(19) United States
(12) Patent Application Publication
(10) Pub. No.: US 2011/0127867 A1
(43) Pub. Date: Jun. 2, 2011

(54) Bearing assembly and scanning motor

(75) Inventors: Song Bon Oh, Suwon (KR); Sang Jae Song, Suwon (KR)

(73) Assignee: SAMSUNG ELECTRO-MECHANICS CO., LTD., Suwon (KR)

(21) Appl. No.: 12/805,243

(22) Filed: Jul. 20, 2010

(30) Foreign Application Priority Data
Dec. 2, 2009 (KR) 10-2009-0118275

(51) Int. Cl. H02K 7/08; F16C 19/00

(52) U.S. Cl. 310/90; 384/450

(57) ABSTRACT

There is provided a bearing assembly including: a sleeve having a hole; a shaft rotatably disposed in the hole; a thrust plate in contact with the end of the shaft to reduce friction in rotation of the shaft; and a holder accommodating the sleeve and the thrust plate and having a contact surface in contact with the thrust plate.

### CROSS-REFERENCE TO RELATED APPLICATIONS

This application claims the priority of Korean Patent Application No. 10-2009-0118275 filed on Dec. 2, 2009, in the Korean Intellectual Property Office, the disclosure of which is incorporated herein by reference.

### BACKGROUND OF THE INVENTION

1. Field of the Invention

The present invention relates to a bearing assembly and a scanning motor, and more particularly, to a bearing assembly designed to reduce vibrations and noise generated in high-speed rotation by improving a support structure for a shaft, and a scanning motor including the bearing assembly.

2. Description of the Related Art

In general, scanning motors including mirror units have been used for laser scanning devices. Such laser scanning devices are used for laser printers, digital copy machines, barcode readers, fax machines and the like.

The mirror unit in theses devices has a plurality of reflective surfaces at the side and deflects incident light emitted from a light source while rotating in a predetermined direction. The mirror unit includes a mirror body having a plurality of rectangular mirror surfaces.

The mirror unit is rotated at a predetermined speed by a driving member for an image-forming operation, such as a motor, such that the laser scanning device reflects a beam in the scanning direction onto a scanned-surface by rotating the mirror unit in this way.

The mirror unit is rotated by a bearing assembly of a scanning motor in the related art and the bearing assembly includes a thrust plate to decrease frictional force on the bottom of the rotating shaft.

In this configuration, the thrust plate and the shaft are in large surface contact with each other. When the thrust plate is inclined by foreign substances and the like in a holder, the shaft inclines with respect to the thrust plate to have a central difference on the rotation center.

Therefore, the center of the shaft does not coincide with the rotation center, such that the motor unit generates noise and vibration in the rotation of the scanning motor, thereby decreasing rotational characteristics. Accordingly, technologies for overcoming the problems are required.

### SUMMARY OF THE INVENTION

An aspect of the present invention provides a bearing assembly designed such that the center axis of a shaft coincides with the rotation center in rotating, and a scanning motor including the bearing assembly.

According to an aspect of the present invention, there is provided a bearing assembly including: a sleeve having a hole; a shaft rotatably disposed in the hole; a thrust plate in contact with the end of the shaft to reduce friction in rotation of the shaft; and a holder accommodating the sleeve and the thrust plate and having a contact surface in contact with the thrust plate.

Further, the shaft of the bearing assembly may be formed such that the end in contact with the thrust plate has a radius of curvature.

Further, the holder of the bearing assembly may be formed such that the contact surface has a radius of curvature larger than a radius of curvature of the shaft.

Further, the holder of the bearing assembly may be formed such that the contact surface is formed in a peak shape to be in point contact with the thrust plate.

Further, the holder of the bearing assembly may have a semispherical contact protrusion protruding from the contact surface to be in point contact with the thrust plate.

Further, the holder of the bearing assembly may have a peak-shaped contact protrusion protruding from the contact surface to be in point contact with the thrust plate.

According to another aspect of the present invention, there is provided a scanning motor including: a bearing assembly including a sleeve having a hole, a shaft rotatably disposed in the hole, a thrust plate in contact with the end of the shaft to reduce friction in rotation of the shaft, and a holder accommodating the sleeve and the thrust plate and having a contact surface in contact with the thrust plate; a stator attached to the holder to fix the position; a rotor unit fitted on the shaft and having a flange rotating with the shaft by electromagnetic force; and a mirror unit bonded and fixed to the outer surface of the flange.

Further, a magnet may be attached to the inner surface of the rotor unit of the scanning motor and a coil may be attached to the holder to correspond to the magnet.

Further, the shaft of the scanning motor may be formed such that the end in contact with the thrust plate has a radius of curvature.

Further, the holder of the scanning motor may be formed such that the contact surface has a radius of curvature larger than a radius of curvature of the shaft.

Further, the holder of the scanning motor may have the contact surface formed in a peak shape to be in point contact with the thrust plate.

Further, the holder of the scanning motor may have a semispherical contact protrusion protruding from the contact surface to be in point contact with the thrust plate.

Further, the holder of the scanning motor may have a peak-shaped contact protrusion protruding from the contact surface to be in point contact with the thrust plate.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating a scanning motor according to an embodiment of the present invention;

FIG. 2 is a schematic cross-sectional view illustrating a bearing assembly of a scanning motor according to an embodiment of the present invention;

FIG. 3 is a schematic cross-sectional view illustrating rotational characteristics of the bearing assembly of the scanning motor shown in FIG. 2;

FIG. 4 is a schematic cross-sectional view illustrating a bearing assembly of a scanning motor according to another embodiment of the present invention; and

FIGS. 5 and 6 are schematic cross-sectional views illustrating a bearing assembly of a scanning motor according to another embodiment of the present invention.

### DETAILED DESCRIPTION OF THE PREFERRED EMBODIMENT

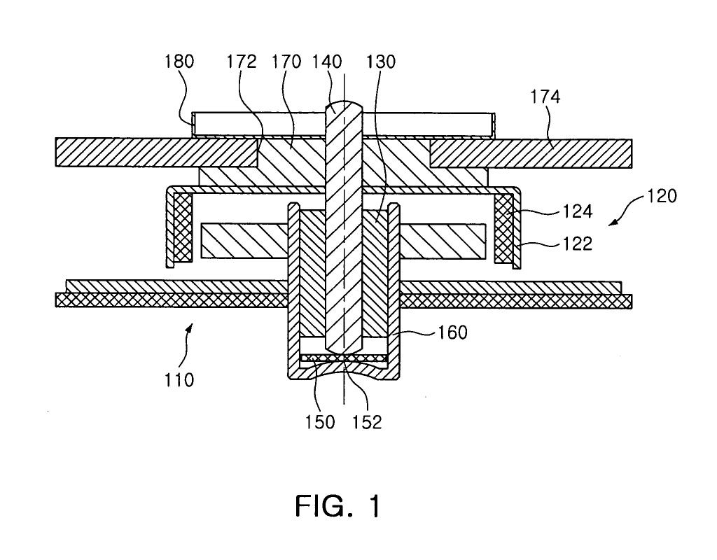

A bearing assembly and a scanning motor according to an embodiment of the present invention are described in more detail with reference to FIGS. 1 through 6. Detailed embodiments of the present invention are described hereafter in detail with reference to the accompanying drawings.

However, it should be noted that the spirit of the present invention is not limited to the embodiments set forth herein and those skilled in the art understanding the present invention can easily accomplish retrogressive inventions or other embodiments included in the spirit of the present invention by the addition, modification, and removal of components within the same spirit, but those are construed as being included in the spirit of the present invention.

The component having the same function within the same spirit of the present invention and represented by the same reference numerals in the drawings relating to the embodiments.

FIG. 1 is a schematic cross-sectional view illustrating a scanning motor according to an embodiment of the present invention.

Referring to FIG. 1, a scanning motor 130 includes a sleeve 130, a shaft 140, a thrust plate 150, and a holder 160.

The lower end portion of the sleeve 130, as shown in FIG. 1, is press-fitted in a receiving hole of the holder 160. The sleeve 130 may be a rotary support member facing a rotor unit 120 at a predetermined distance and forming a slide surface therebetween.

Further, the sleeve 130 may have a shaft-hole in which the shaft 140 is fitted and a plurality of radial dynamic-pressure grooves is formed on the inner surface of the shaft-hole.

The shaft 140 can rotate in the sleeve 130 and a hub 122 is fitted on the upper portion of the shaft 140.

In this configuration, the shaft 140 may be formed lengthwise in the direction of a rotational axis and the thrust plate 150 is disposed under the lower end of the shaft 140 to reduce friction force generated by rotation of the shaft 140.

The thrust plate 150 has the bottom thereof being in contact with the convex surface of the holder 160 while being in contact with the shaft 140 in the holder 160. The upper surface of the thrust plate 150 is in contact with the lower end of the shaft 140 and decreases friction force generated by the rotation of the shaft 140.

The holder 160 accommodates the sleeve 130 and the shaft 140 and the thrust plate 150 may disposed on the bottom of the holder 160, as described above.

The contact surface 152 of the holder 160 which is in contact with the thrust plate 150 may be depressed toward the surface in contact with the thrust plate 150. Therefore, the contact surface 152 is formed to have the radius of curvature larger than that of the shaft 140. According to this configuration, the contact surface 152 depressed inside presses the holder 160 inside.

The configuration shown in FIG. 1 is described in detail hereafter.

A stator 110 is a fixed member including a wound coil generating a predetermined magnitude of electromagnetic force when power is supplied and a plurality of cores with the coils wound thereupon.

The stator 110 is combined by the shaft 140 of the rotor unit 120 such that the coil faces a magnet 124 attached to the inner surface of the hub 122. Therefore, the rotor unit 120 is rotatably fixed to the stator that does not move.

The rotor unit 120, as described above, is a rotary member that can rotate with respect to the stator and may include the hub 122 having arc-shaped magnets 124, which face each other with the core at a determined therebetween, on the outer circumference.

Further, the magnet 124 is a permanent magnet circumferentially alternately magnetized with N and S poles to produce a predetermined magnitude of magnetic force.

Further, the hub 122 may have an extension 126 formed such that a polygon-mirror unit 174 is spaced upward apart from the surface equipped with the magnet 124.

A flange 170 has a flange hole 172 for fitting the shaft 140 and may be formed to have the same circular shape as the shaft 140.

The outer surface of the flange 170 can be bonded to a through-hole of the polygon-mirror unit 174, such that the polygon-mirror unit 174 rotates with the flange 170, when the flange 170 rotates with the rotational axis of the rotor unit 120.

A mirror surface is formed on the outer surface of the polygon-mirror unit 174 and deflects incident light emitted from a light source while rotating in a predetermined direction. Further, a fixing member 180 that is fitted on the shaft 140 to fix the polygon-mirror unit 174 may be disposed on the polygon-mirror unit 174.

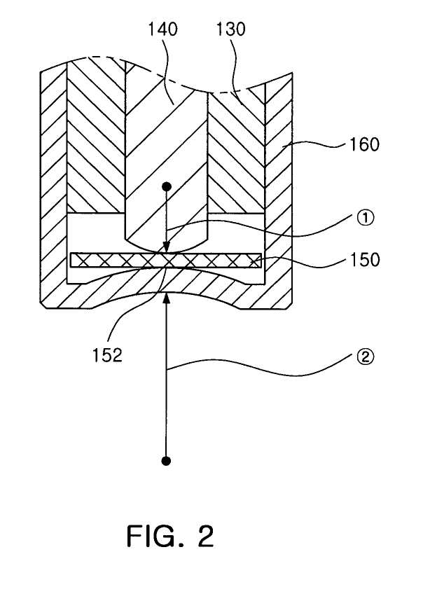

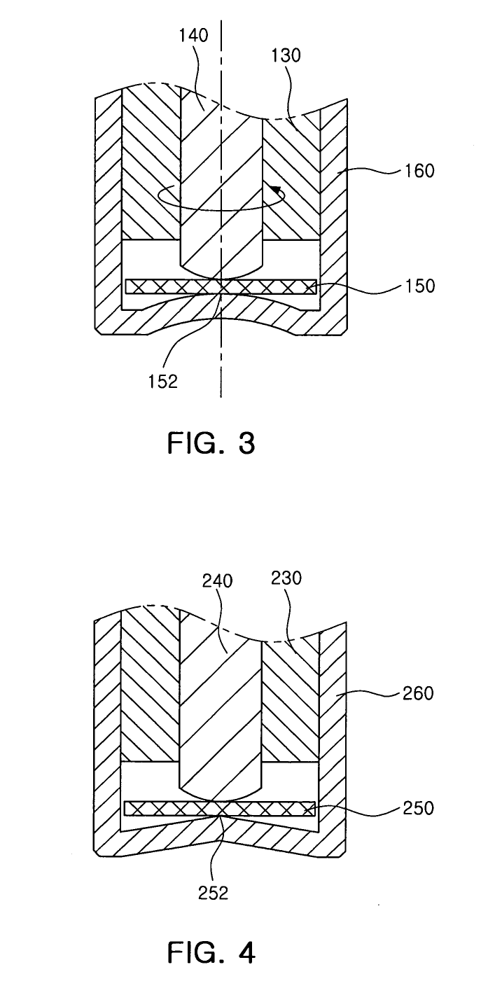

FIG. 2 is a schematic cross-sectional view illustrating a bearing assembly of a scanning motor according to an embodiment of the present invention and FIG. 3 is a schematic cross-sectional view illustrating rotational characteristics of the bearing assembly of the scanning motor shown in FIG. 2.

Referring to FIG. 2, the holder 160 is formed such that the contact surface 152 has a radius of curvature \textcircled{2} larger than a radius of curvature \textcircled{1} of the shaft 140.

Therefore, the shaft 140 is in point contact with the thrust plate 150 and the thrust plate 150 is in point contact with the contact surface 152 of the holder 160, such that the rotation center of the shaft 140 coincides with the center of the holder.

Accordingly, the holder 160 can prevent the thrust plate 150 and the shaft 140 from inclining.

Further, as shown in FIG. 3, the shaft 140 is in point contact with the thrust plate 150 disposed in the holder 160 and the center of the shaft 140 coincides with the rotation center by this contact structure.

Therefore, since the bearing assembly and the scanning motor according to this embodiment includes the holder 160 having the contact surface which is in point contact with the thrust plate 150, with the sleeve 130 and the thrust plate 150 therein, the thrust plate 150 can be prevented from inclining by the holder 160, and accordingly, the center of the shaft 140 coincides with the rotation center, such that it is possible to improve rotational characteristics.

FIG. 4 is a schematic cross-sectional view illustrating a bearing assembly of a scanning motor according to another embodiment of the present invention.

Referring to FIG. 4, a scanning motor may include a sleeve 230, a shaft 240, a thrust plate 250, and a holder 260.

The sleeve 230, shaft 240, and thrust plate 250 of this embodiment are substantially the same as those of the above embodiment and the detailed description is therefore not provided.

In this embodiment, a contact surface 252 of the holder 260 is in point contact with the thrust plate 250 and the shape of the contact surface 252 may be formed in a peak shape. Further, the peak-shaped contact surface 252 may be simply formed to press the bottom of the holder 260.

Therefore, the bearing assembly and the scanning motor according to this embodiment includes the holder 260 having the contact surface being in point contact with the thrust plate 250, with the sleeve 230 and the thrust plate 250 therein, the thrust plate 250 can be prevented from inclining by the holder 260.

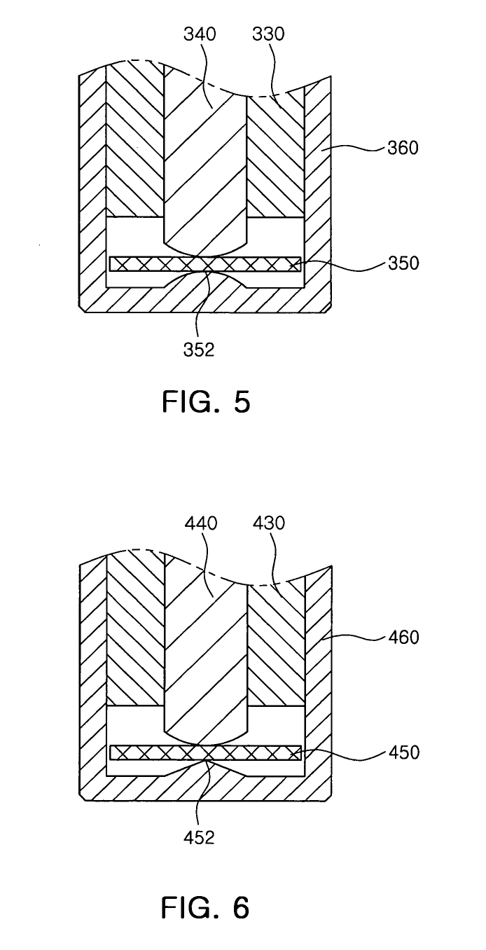

FIGS. 5 and 6 are schematic cross-sectional views illustrating a bearing assembly of a scanning motor according to other embodiments of the present invention.

Referring to FIG. 5, a scanning motor may include a sleeve 330, a shaft 340, a thrust plate 350, and a holder 360.

The sleeve 330, shaft 340, and thrust plate 350 are substantially the same as those in the above embodiments and the detailed description is not provided.

The bottom of the holder 360 may have a protrusion, which may be formed to protrude in manufacturing. The protrusion may have the end rounded in the cross section. Therefore, the highest portion of the protrusion is a contact surface 352.

Referring to FIG. 6, the bottom of a holder 460 may have a protrusion, which may be formed in manufacturing. The protrusion may be formed in a peak shape in the cross section. Therefore, the highest portion of the protrusion is a contact surface 452. However, the shape of the protrusion of the holder 360 is not limited thereto and may be formed in various shapes by the designer's intention.

As set forth above, according to exemplary embodiments of the invention, a bearing assembly and a scanning motor includes a holder accommodating a sleeve and a thrust plate and having a contact surface being in point contact with the thrust plate, such that the thrust plate can be prevented from inclining by the holder, and accordingly, the center of the shaft coincides with the rotational center, thereby improving rotational characteristics.

While the present invention has been shown and described in connection with the exemplary embodiments, it will be apparent to those skilled in the art that modifications and variations can be made without departing from the spirit and scope of the invention as defined by the appended claims.

What is claimed is:

1. A bearing assembly comprising:
a sleeve having a hole;
a shaft rotatably disposed in the hole;
a thrust plate in contact with the end of the shaft to reduce friction in rotation of the shaft; and
a holder accommodating the sleeve and the thrust plate and having a contact surface in contact with the thrust plate.

2. The bearing assembly of claim 1, wherein the shaft is formed such that the end in contact with the thrust plate has a radius of curvature.

3. The bearing assembly of claim 2, wherein the holder is formed such that the contact surface has a radius of curvature larger than a radius of curvature of the shaft.

4. The bearing assembly of claim 1, wherein the holder is formed such that the contact surface is formed in a peak shape to be in point contact with the thrust plate.

5. The bearing assembly of claim 1, wherein the holder has a semispherical contact protrusion protruding from the contact surface to be in point contact with the thrust plate.

6. The bearing assembly of claim 1, wherein the holder has a peak-shaped contact protrusion protruding from the contact surface to be in point contact with the thrust plate.

7. A scanning motor comprising:
a bearing assembly including a sleeve having a hole, a shaft rotatably disposed in the hole, a thrust plate in contact with the end of the shaft to reduce friction in rotation of the shaft, and a holder accommodating the sleeve and the thrust plate and having a contact surface in contact with the thrust plate;
a stator attached to the holder to fix the position;
a rotor unit fitted on the shaft and having a flange rotating with the shaft by electromagnetic force; and
a mirror unit bonded and fixed to the outer surface of the flange.

8. The scanning motor of claim 7, wherein a magnet is attached to the inner surface of the rotor unit and a coil is attached to the holder to correspond to the magnet.

9. The scanning motor of claim 7, wherein the shaft is formed such that the end in contact with the thrust plate has a radius of curvature.

10. The scanning motor of claim 9, wherein the holder is formed such that the contact surface has a radius of curvature larger than a radius of curvature of the shaft.

11. The scanning motor of claim 7, wherein the holder has the contact surface formed in a peak shape to be in point contact with the thrust plate.

12. The scanning motor of claim 7, wherein the holder has a semispherical contact protrusion protruding from the contact surface to be in point contact with the thrust plate.

13. The scanning motor of claim 7, wherein the holder has a peak-shaped contact protrusion protruding from the contact surface to be in point contact with the thrust plate.
